(19) United States
(12) Patent Application Publication
(10) Pub. No.: US 2012/0194037 A1
(43) Pub. Date: Aug. 2, 2012

(54) Apparatus and Method for Harvesting Electrical Energy from Mechanical Motion

(75) Inventors: Jeffery B. Moler, Sarasota, FL (US); Martin C. Maxwell, Moreland Hills, OH (US); Edward Troy Tanner, Williamsburg, VA (US)

(73) Assignees: PARKER HANNIFIN CORPORATION, Cleveland, OH (US); VIKING AT, LLC, Sarasota, FL (US)

(21) Appl. No.: 13/499,014

(22) PCT Filed: Oct. 1, 2010
(86) PCT No.: PCT/US10/51124

§ 371 Date: Apr. 17, 2012

Related U.S. Application Data
(60) Provisional application No. 61/277,970, filed on Oct. 1, 2009.

(30) Foreign Application Priority Data
Jul. 9, 2010 (US) PCT/US2010/041461

(51) Int. Cl. H02N 2/18

(52) U.S. Cl. 310/339

(57) ABSTRACT

A method and apparatus for harvesting energy comprising determining an electrical impedance of a piezoelectric stack, connecting an electrical load to the piezoelectric stack wherein the piezoelectric stack is housed in a mechanical amplifier comprising a fixed supporting member, a movable supporting member connected to compliant links attached to at least one actuating arm, and connecting the actuator to a source of motion whereby movement of the actuating arm results in compression and expansion of the piezoelectric stack, which generates electrical current into the electrical load.

### CROSS-REFERENCE TO RELATED APPLICATION

This application claims the benefit of U.S. Provisional Patent Application No. 61/277,970, filed Oct. 1, 2009, the contents of which are herein incorporated by reference. This application additionally claims the benefit of International Application No. PCT/US10 041,461, filed Jul. 9, 2010, the contents of which are herein incorporated by reference.

### BACKGROUND

The present disclosure relates to an apparatus and method for generating electrical energy from mechanical motion using a piezo actuator or other smart material device. Electromechanical vibration energy harvesting devices are known in the art. However, such devices are inefficient and do not operate on piezo-electric principles. The present disclosure corrects these shortcomings by providing a piezo-electric actuator and a method of utilizing said actuator to convert mechanical motion to electrical energy.

This application hereby incorporates by reference U.S. Publication Number 2005/0231077 and U.S. patents:

6,717,332;
6,548,938;
6,737,788;
6,836,056;
6,879,087;
6,759,790;
7,132,781;
7,126,259;
6,870,305;
6,975,061;
7,368,856; and
6,924,586.

### BRIEF DESCRIPTION OF THE DRAWINGS

Other features in the disclosure will become apparent from the attached drawings, which illustrate certain preferred embodiments of the apparatus of this disclosure, wherein

FIG. 1 shows a side view of a preferred embodiment of an actuator in accordance with the present disclosure;

FIG. 2 shows an isometric view of a preferred embodiment of an actuator in accordance with the present disclosure;

FIG. 3 shows an isometric view of a section of a preferred embodiment of a piezoelectric stack suitable for use with an apparatus in accordance with the present disclosure;

FIG. 4 illustrates a preferred embodiment of a multilayer piezoelectric stack suitable for use with an apparatus in accordance with the present disclosure;

FIG. 5 illustrates an alternate embodiment of a mechanical amplifier suitable for use with an apparatus in accordance with the present disclosure;

FIG. 6 illustrates an alternate embodiment of a mechanical amplifier suitable for use with an apparatus in accordance with the present disclosure;

FIG. 7 is a graph illustrating the voltage produced by a preferred embodiment of the apparatus of the present disclosure;

FIG. 8 is a graph illustrating the power/load characteristics of a preferred embodiment of the apparatus of the present disclosure;

FIGS. 9-10 are graphs illustrating the power/displacement characteristics of a preferred embodiment of the apparatus of the present disclosure;

FIG. 11 is a graph illustrating the voltage output of a preferred embodiment of the apparatus of the present disclosure;

FIG. 12 is a graph illustrating the current output of a preferred embodiment of the apparatus of the present disclosure;

FIG. 13 is a graph illustrating the power output of a preferred embodiment of the apparatus of the present disclosure;

FIG. 14 is a graph illustrating the energy produced by a preferred embodiment of the apparatus of the present disclosure;

FIG. 15 is a graph illustrating discharge versus electrical load of a preferred embodiment of the apparatus of the present disclosure;

FIG. 16 is a graph illustrating capacitance characteristics of a preferred embodiment of the apparatus of the present disclosure;

FIG. 17 is a graph illustrating voltage decay characteristics of a preferred embodiment of the apparatus of the present disclosure; and

FIG. 18 is a graph illustrating the stored energy characteristics of a preferred embodiment of the apparatus of the present disclosure.

### DETAILED DESCRIPTION

While the following describes preferred embodiments of the present disclosure, it is to be understood that this description is to be considered only as illustrative of the principles of the disclosure and is not to be limitative thereof, as numerous other variations, all within the scope of the disclosure, will readily occur to others. The term “adapted” shall mean sized, shaped, configured, dimensioned, oriented and arranged as appropriate.

The energy harvesting apparatus 1 of the present disclosure comprises a mechanical amplifier 10 connected to a piezoelectric stack 100 or other smart material device adapted such that when mechanical force is applied to the amplifier 10, the piezoelectric stack 100 or other smart material device is subjected to a mechanical load, there by generating an electrical current.

The energy harvesting apparatus 1 in accordance with the present disclosure can function either as an actuator, turning electrical energy into mechanical motion of the actuating arm 40 of the apparatus 1. Alternatively, as discussed in more detail below, the actuator can be used in a reverse configuration, whereby mechanical force is applied to the actuating arm 40. The actuator amplifies this mechanical force and directs it into a piezoelectric stack 100 (or other smart material). Subjecting the piezoelectric stack 100 to the mechanical load causes it to generate electricity. This electrical current can then be directed to an energy collection device, such as a battery. It is to be understood throughout this disclosure that an actuator in accordance with the present disclosure can function both as an actuator, converting electrical energy to mechanical movement, as well as in reverse, converting mechanical movement into electrical energy.

The actuator is comprised of a rigid support structure and a smart material such as a piezo stack or other smart material device that is contained within or by the rigid structure. The rigid structure is preferably designed to focus energy and displacement from or to the smart material in one axis and maintain a uniform surface contact with the actuator on both ends so that side-loading or uneven forces across the faces are minimized or eliminated, thereby improving and focusing energy transfer along one axis. The support structure also allows the smart material actuator to be preloaded to a predetermined level, thus enabling use of the optimization of work from a smart material actuator via preload level (as further described in the incorporated references), and also allowing a preload level that changes the coefficient of thermal expansion of the smart material actuator via preload level (as also further described in the incorporated references), so as to optimize the thermal stability of the apparatus.

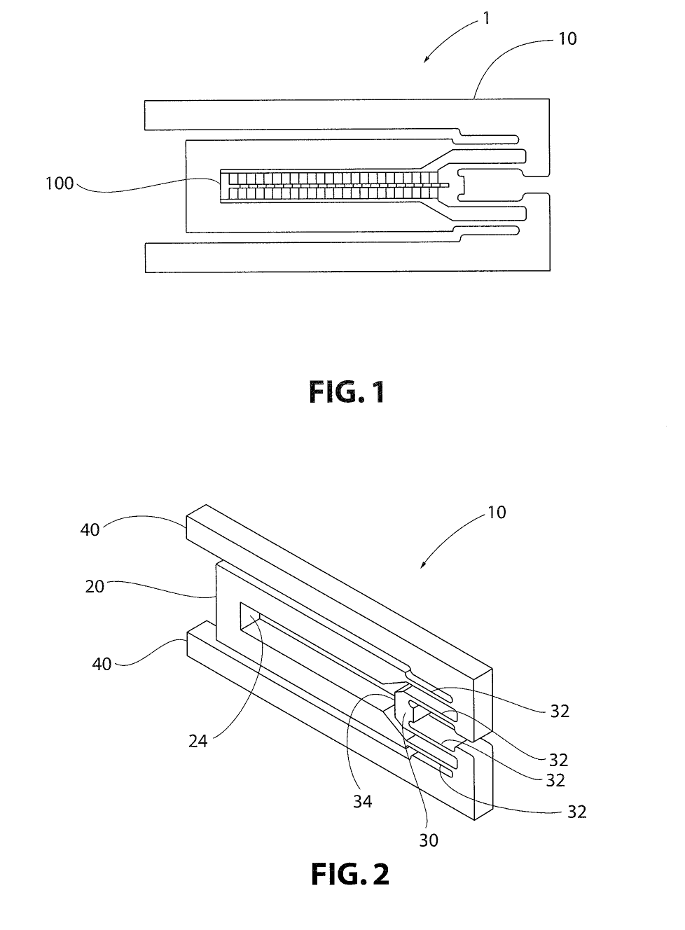

FIG. 1 illustrates a preferred embodiment of the actuator apparatus 1 in accordance with the present disclosure, with FIG. 2 illustrating an isometric view of the mechanical amplifier of actuator 1. The overall length of the actuator may conveniently be 100 mm-200 mm or larger, allowing for use in a variety of applications where larger sized actuators are impractical. Utilizing the structures and methods of the present disclosure, actuators substantially smaller than 10 mm are also possible, with actuators having a length of 1 mm or less being practical.

Actuator 1 comprises a mechanical amplifier 10 and piezoelectric stack 100. Mechanical amplifiers of larger-sized actuators may be assembled from discrete components (not pictured). Alternatively, smaller amplifiers may be formed from a single piece of material. That material may be a metal such as stainless steel, from which high-precision laser cutting or chemical etching is used to cut the shape of mechanical amplifier 10. In alternate embodiments, mechanical amplifier 10 may be formed from silicon via the etching process traditionally used to form semiconductors, thereby leading to even smaller actuator bodies. Other materials such as carbon fiber, plastics, or ceramics may also be used, depending on the application. Stainless steel is one preferred material as it allows for an appropriate level of stiffness and durability, and also may be formed in a manner that creates useful working surfaces (such as blades) integrally formed in convenient locations on mechanical amplifier 10.

A preferred embodiment of mechanical amplifier 10 comprises fixed supporting member 20 having first mounting surface 24. Fixed supporting member 20 serves the purpose of rigidly supporting piezoelectric stack 100 with a suitable preload compression as is discussed further below. First mounting surface 24 is preferably shaped to connect firmly and evenly with piezoelectric stack 100, with an optional insulator 101 (shown on FIG. 4), as is discussed further below. Firm and even mating between mounting surface 24 and piezoelectric stack 100 is desirable as it acts to minimize angular flexing of piezoelectric stack 100 during operation, thereby improving the operational lifetime and efficiency of actuator 1.

Mechanical amplifier 10 further comprises opposed movable supporting member 30, which has second mounting surface 34. Piezoelectric stack 100 is affixed between first mounting surface 24 and second mounting surface 34. While adhesives may be used to secure piezoelectric stack 100, in certain embodiments such adhesives are not necessary as the compressive force supplied by movable supporting member 30 pressing piezoelectric stack 100 against first mounting surface 24 of fixed supporting member 20 will generally be sufficient to secure piezoelectric stack 100 in place. It is accordingly convenient for fixed supporting member 20 to be substantially rigid and for movable supporting member 30 and second mounting surface 34 to be parallel and directly opposed to fixed supporting member 20 and first mounting surface 24. As with first mounting surface 24, it is desirable that second mounting surface 34 be adapted to meet piezoelectric stack 100 firmly and evenly. In this way, upon application of a suitable electrical potential to piezoelectric stack 100, piezoelectric stack 100 will expand substantially without angular movement caused by flexing, thereby allowing for longer duty cycles and more efficient operation. Similarly, when operated to gather energy as disclosed herein, the force generated by moving the actuator arm (discussed below) is amplified and directed efficiently into the piezoelectric stack 100 so as to maximize the amount of energy output from the piezoelectric stack 100.

The illustrated embodiment of actuator 1 further comprises actuating arms 40, which are joined with fixed supporting member 20 and movable supporting member 30 by mechanical links 32. Mechanical links 32 (also called webs) are compliant and adapted such that urging movable supporting member 30 away from fixed supporting member 20 will cause mechanical links 32 to flex, thereby causing actuator arms 40 to move toward one another. The longer actuating arms 40 are, the greater the movement at their ends. Accordingly, the design of mechanical amplifier 10 amplifies the mechanical motion created by piezoelectric stack 100 into greater mechanical motion at the ends of actuator arms 40. In this way, actuator 1 may be activated by applying an electric potential to piezoelectric stack 100, thereby causing it to expand and urge second movable supporting member 30, which causes corresponding but amplified movement of actuator arms 40. As is discussed further below, reverse operation is also possible in which at least one actuator arm 40 is moved by a mechanical force, thereby causing movable supporting member 30 to alternately compress and expand piezoelectric stack 100, which in turn causes piezoelectric stack 100 to generate an electric potential which can then be discharged into an electrical load such as a rechargeable power source (not shown). Accordingly, it is understood that actuator 1 may be used as an actuator that creates mechanical motion from electrical energy by applying an appropriate electrical potential to piezoelectric stack 100, or as a generator that harvests electrical energy from mechanical motion by attaching actuator arms 40 to a source of mechanical energy such as a muscle fiber or a vibrating or oscillating device, and then discharging the electric potential created by the expansion and compression of piezoelectric stack 100 into an energy storage device such as a rechargeable battery or a capacitor.

The amount of electric potential (or voltage) generated by piezoelectric stack 100 will be proportional to the amount of movement of actuator arm(s) 40. Accordingly, by analyzing the amount of energy harvested, the degree of movement of actuator arms 40 can be determined.

If mechanical amplifier 10 is formed from an electrically conductive material such as metal, it is convenient to insert an insulator 101 (shown on FIG. 4) between at least one end of piezoelectric stack 100 and either first mounting surface 24 or second mounting surface 34. This enables the body of mechanical amplifier 10 to be electrically connected to one pole of piezoelectric stack 100, serving, for example, as a ground. In the event piezoelectric stack 100 is adapted such that both first mounting surface 24 and second mounting surface 34 connect to sections of piezoelectric stack 100 having the same polarity, or if mechanical amplifier 10 is formed from a non-conductive material, insulators 101 are not needed.

It will be understood by those of skill in the art that while the operational dynamics of mechanical amplifier 10 constrain the design of fixed supporting member 20, movable supporting member 30 and mechanical links 32, actuating arms 40 may be formed in a wide variety of sizes and configurations depending on the desired application for actuator 1. For example, and without limitation, there may be only a single actuating arm 40 with the opposite actuating arm 40 replaced with a mounting surface (not shown) adapted for attachment to a fixed surface (not shown); actuating arms 40 may be angled away from piezoelectric stack 100, may be curved, or may have integral features such as blades, barbs, points, or mechanical attachments. Different actuating arm features could similarly be used to capture electrical energy from fluid or gas flow within a body.

It will be further understood that while longer actuator arms 40 will result in greater stroke of actuator 1, that stroke will be with less force. If greater force is needed and less stroke length is acceptable, shorter actuating arms 40 may be used instead.

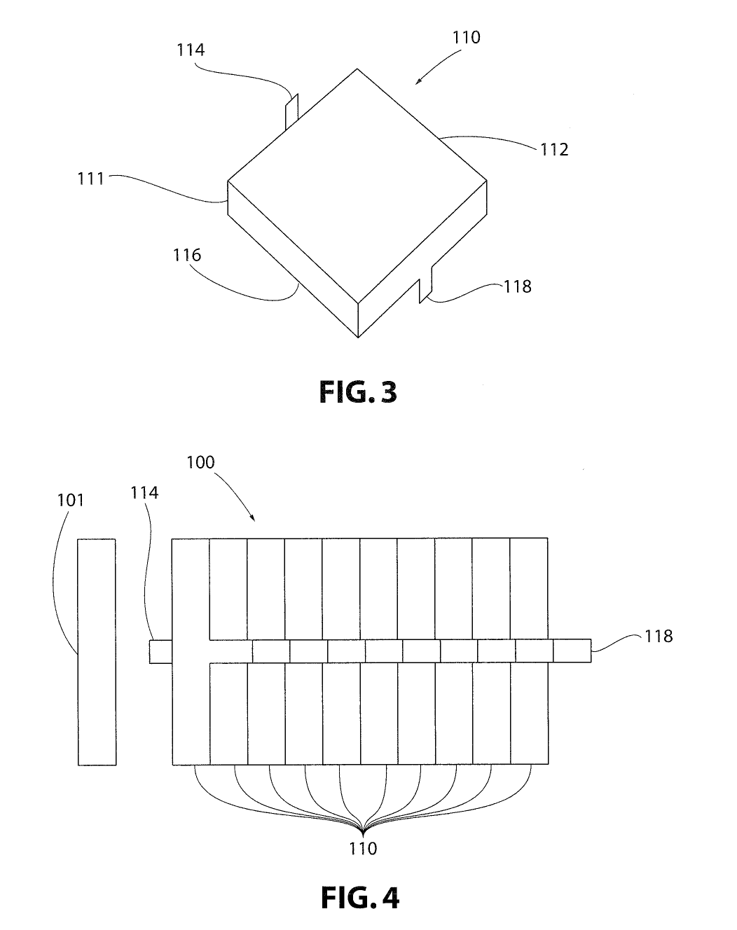

Referring to FIGS. 3 and 4, Piezoelectric stack 100 is preferably formed of one or more sections of piezoelectric material 111 with a positive electrode 112 and a negative electrode 116. Many varieties of piezoelectric materials (materials that expand when an electric potential is applied or generate an electric charge when mechanical force is applied) are known in the art and may be adapted for use in the present disclosure. As discussed herein, the term piezoelectric material also includes so-called “smart materials,” sometimes created by doping known piezoelectric materials to change their electrical or mechanical properties.

One type of piezoelectric stack 100 suitable for use in certain embodiments of actuator 1 of the present disclosure are multilayer piezoelectric stacks. Such stacks are known in the art and generally comprise sections 110 of piezoelectric material 111, each having opposing positive electrode 112 and negative electrode 116. Positive terminal 114 and negative terminal 118 may be used for convenient attachment of wires or conductive strips so that an electric charge can be applied and the sections 110 in a stack 100 may be electrically joined. Upon such application, piezoelectric material 111 will expand. Alternatively, upon compression of piezoelectric material 111, an electric potential will be created between electrodes 112 and 116. By stacking multiple layers together, the expansion and electrical harvesting characteristics are added together. By alternating the direction of piezoelectric sections 110 so that positive electrodes 112 are adjacent to positive electrodes 112, and negative electrodes 116 are adjacent to negative electrodes 116 when stacked, insulators between sections 110 are not needed. Where the piezoelectric stack 100 is inserted into a conducting structure (such as a mechanical amplifier formed of metal), it may be necessary to include an insulator 101 on one end. If, however, piezoelectric stack 100 is configured such that the terminals 114, 118 at each end are the same polarity (i.e. by having an even number of alternately stacked sections 110), then no insulator 101 is needed.

One type of multilayer piezoelectric stack 100 suitable for use with the present disclosure is a co-fired, multilayer ceramic piezoelectric stack. Such piezoelectric stacks may be formed by printing electrodes on either end of a ceramic piezoelectric material 111 using known techniques. The layers are then stacked and fired together to create a unitary structure. Such stacks are available from a number of suppliers, including NEC. Such stacks are convenient for use in actuators 1 having dimensions on the order of 2 mm in length and much higher, 0.5 mm to 1 mm in thickness and 1 mm in width and much larger. In one embodiment, piezoelectric stacks may be 10-40 mm in length and 5 mm×5 mm to 10 mm×10 mm. As will be understood by those of skill in the art, this is only one example and many different stack sizes can be formed using different numbers of layers, and different layer thicknesses, thereby providing for actuators suitable for a wide variety of applications.

Another type of multilayer piezoelectric stack 100 suitable for use with the present disclosure is a stack 100 formed of sections 110 of a single-crystal piezo material. Single-crystal piezo materials are known in the art and can be created in a variety of configurations. Single-crystal piezo materials are generally thought to be more efficient than co-fired ceramic materials. As such, less material may be used to generate effects comparable to larger co-fired stacks. Piezoelectric stacks 100 formed of single-crystal piezoelectric materials may conveniently be used in even smaller embodiments of actuators 1 of the present disclosure, including sizes, for example, of 1 mm in length (the lengthwise axis being the axis along which the crystal predominantly expands upon application of an electric current to the crystal), and 0.3 mm square. As is shown in FIG. 6, when shorter stacks 100 are used, actuator arms 40 may extend well beyond fixed supporting member 20. Once again, it will be clear to those of ordinary skill in the art that many different sizes, including both larger and smaller sizes, may be created using such stacks.

In forming stacks of single crystal material, it can be desirable to use a conducting or insulating adhesive between the layers to add to the structural strength of the stack. In this way, when inserted into actuator 1, stack 100 will be held together both by the compressive forces created by fixed supporting member 20 and movable supporting member 30 and by the adhesive between the layers. Similarly, adhesive may be used between stack 100 and mounting surfaces 24, 34 to hold stack 100 in place as well as, or instead of, forming mounting surfaces 24, 34 with structural features such as ridges or tabs adapted to hold stack 100 in place.

Piezoelectric stack 100 will benefit from being compressed by a predetermined amount, thereby creating a preload, such that the piezoelectric stack 100 remains compressed when no electric potential is applied. Any such compressive force should be substantially evenly applied such that upon application of an electric potential, the piezoelectric stack 100 expands without substantial angular flexing. Reducing flexing both increases the efficiency of stack 100 and also increases its operational life.

Determining the proper level of predetermined compression, or preload, may be accomplished by applying different preload levels, and for each preload level, plotting the stroke at various blocking force levels. The preload level for which the integral of such curve for the required stroke and blocking force level is maximized is preferred.

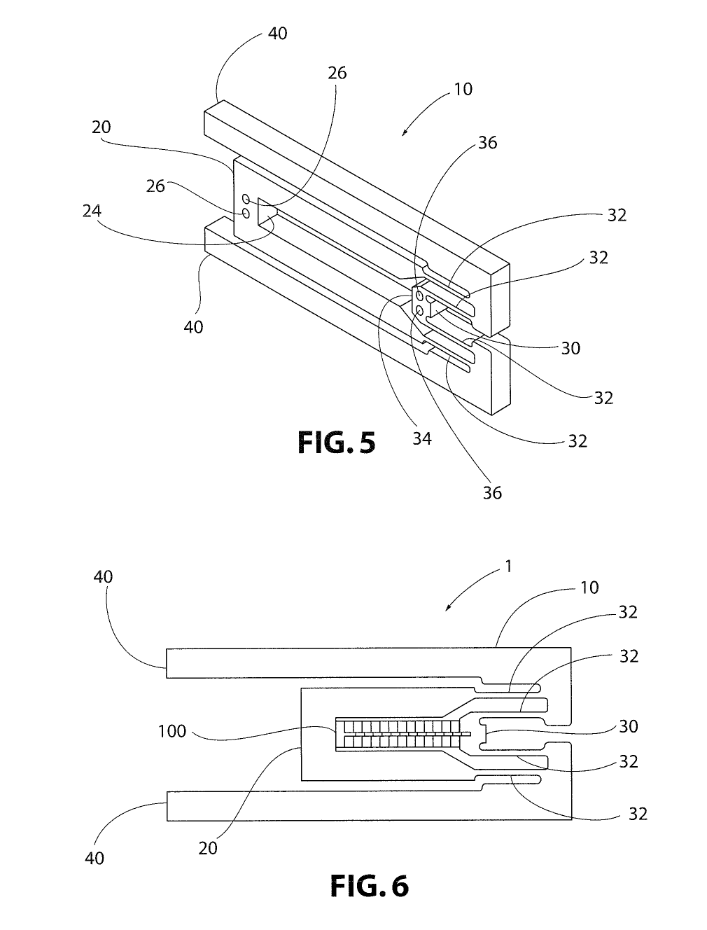

On larger actuators, preload may be achieved by incorporating a threaded bolt (not pictured) or means of mechanical compression into movable supporting member 30 or fixed supporting member 20. In very small actuators, such mechanical compression means can become impractical. Accordingly, embodiments of the actuator of the present disclosure may conveniently rely on the spring rate of mechanical links 32 to provide the needed preload. By determining the necessary preload level and resulting compression of stack 100, mechanical amplifier 10 may be designed with mechanical links 32 adapted such that when actuating arms 40 are in the desired starting position, the appropriate preload results on stack 100 by virtue of the spring rate of the mechanical links 32, thereby eliminating the need for unwieldy mechanical compression mechanisms. In such embodiments, actuating arms 40 may be angled away from fixed supporting member 20 to a greater degree before insertion of piezoelectric stack 100. In such embodiments, piezoelectric stack 100 may be inserted by compressing actuating arms 40, inserting stack 100, and then releasing actuating arms 40. As is shown in FIG. 5, an alternate installation method may be used by forming preferably 2 holes 26 in fixed supporting member 20 and another 2 holes 36 in movable supporting member 30. In this way a tool (not shown) having 4 pins adapted to be captured by holes 26, 36 may be used to urge first mounting surface 24 and second mounting surface 34 apart a sufficient amount to allow for the insertion of stack 100. By forming holes 26, 36 in a rectangular pattern, the force applied by such tool will be applied evenly so that undesirable twisting is minimized.

Where the spring rate of mechanical links 32 are used for compressive force, and the size of mechanical amplifier 10 is small, it is important that mechanical links 32 are adapted such that they do not reach their yield point during normal operation, and such that piezoelectric stack 100 does not go into an uncompressed state during such operation. The yield point of mechanical links 32 will be reached if they are flexed to a point where they do not thereafter return to their starting position. If the yield point is exceeded during operation, stroke will be affected. The level of preload may also change, thereby reducing efficiency. Preventing piezoelectric stack 100 from attaining an uncompressed state is similarly important as the life of such stacks may be significantly reduced if they are operated in an uncompressed state for reasons including that cracking is more likely to occur. As will be understood by those of skill in the art, by determining the required stroke and force needed, and then selecting an appropriate stack 100 capable of generating such force, it is possible to design mechanical links 32 to provide a preferred level of preload and, in combination with actuating arms 40, a preferred level of mechanical amplification to achieve a desirable stroke/force combination, while preventing stack 100 from going into an uncompressed state during normal operation. Different materials having different spring rates will, accordingly, require different configurations of mechanical amplifier 10 to achieve comparable results.

The apparatus described above can be used in a preferred embodiment to harvest energy by transforming mechanical motion into electrical energy. Because the amplifier disclosed herein focuses mechanical energy extremely well, the piezoelectric stack 100 efficiently converts mechanical motion into electrical energy. In this way, the mechanical energy generated when stack 100 is repeatedly compressed and released by actuating arms 40 may be harvested by discharging the current into an electrical load such as an energy storage device. In this way, for example, excess mechanical energy could be converted into electrical energy that is then stored (i.e. in a rechargeable battery).

The actuator of the present disclosure (as further described above and in the incorporated references and hereinafter referred to as the ViVa or Viking actuator) is a highly efficient means of leveraging a piezo or other smart material device to obtain a different force to stroke ratio with small translation losses. Connecting the end of a ViVa actuator to a source of vibration or other mechanical motion or force, generates a charge within said piezo or other smart material. Said charge can then be harvested by allowing it to discharge into an electrical load. The result is a very efficient method of translating mechanical energy into electrical energy that can be utilized to generate electrical current from waste vibration or mechanical motion in a wide variety of applications.

In an alternate embodiment, rather than vibrating the actuator, a force strikes or stresses the actuator into a first position, and then releases the actuator. The actuator will then oscillate back and forth, compressing and expanding the piezoelectric stack 100. As the oscillating actuator slows, the amount of electricity generated will diminish. When the amount of electricity generated drops below a threshold, the actuator can be stressed or struck again, causing it to oscillate further. Thus, a mechanical force can be intermittently applied to an actuator as described herein, allowing the piezoelectric stack 100 to convert the oscillating reverberation motion into electricity.

The ViVa actuator provides an efficient mechanical amplifier that works well in the energy harvesting method and apparatus of the present disclosure. The rigidity, stroke, and mass of the ViVa actuator may be further optimized for energy harvesting by increasing the amplitude of displacement before any portion of the device yields and decreasing mass, thereby resulting in an increase in resonant frequency. Additional stiffening of the parallel supporting members and mechanical links of the actuator can further increase the efficiency of the energy harvesting.

### Test Results

Tests were performed on the 3 mm, 6 mm and 7.5 mm Viking actuators. The goal of this testing effort was to quantify the performance of the Viking actuators in accordance with the present disclosure.

Set-up and Procedure: Performance of the method and apparatus of the present disclosure may be measured by determining the electrical output of the actuators when subjected to a known excitation. In the tests the actuators were excited by fixing the actuator in a vise, displacing the free actuating arm 40 by a precisely measured initial displacement, and then releasing the actuating arm 40 to oscillate. This was accomplished by placing a steel rod and a feeler gage between the two actuating arms 40 of the actuator (or between the actuating arm 40 and the top surface of the vise in the case of the 3 mm actuator) to initially displace it. A dial indicator was used to measure the initial displacement of the actuating arm and the thickness of the feeler gage was adjusted until the desired initial displacement was achieved. The dial indicator was then removed and the feeler gage was pulled out quickly allowing the actuating arm 40 of the actuator 1 to oscillate. This set-up produced an acceptably repeatable excitation to the actuator 1.

When the feeler gage was removed quickly (the steel rod falls cleanly out as well) the free actuator arm 40 springs back towards its initial position and begins to oscillate. This cyclically strains the piezoelectric stack 100 and the stack 100 outputs an oscillating voltage proportional to the cyclic strain. A resistor substitution box was connected across the output leads of the actuator 1 to simulate a connected electrical load. The output voltage of the actuator 1 was then measured across the resistive load. An EasySync Stingray USB Oscilloscope was used to capture the voltage data.

Since the amplitude of the voltage output of the actuators 1 and their electrical impedance were unknown a series of tests were performed to get a baseline. This was accomplished by subjecting the 7.5 mm actuator 1 to a series of tests with a fixed initial displacement of 0.050 inches. First the open circuit voltage was recorded followed by the voltage into various resistive loads.

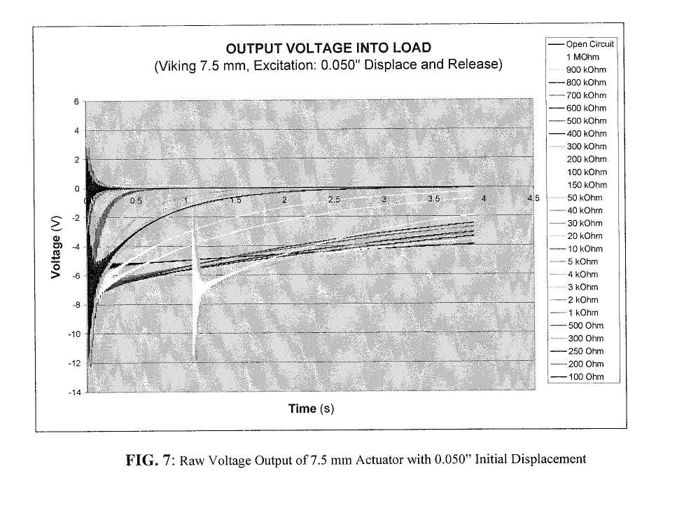

FIG. 7 is a plot of the voltage traces recorded during these tests. In FIG. 7 it can be seen that the initial displacement of 0.050 inches creates an oscillating voltage output from the actuator that is superimposed on a DC voltage. Thus the initial step displacement charges the stack capacitance to a DC value that is dependent on the initial displacement and an overriding oscillating voltage is superimposed on the DC voltage due to the cyclical strain induced on the stack by the oscillating actuator structure. This is important to note as it demonstrates that a step change in displacement can be used in an application to generate useful power even in the absence of the free vibration of the actuator. Also in FIG. 7 it can be seen that following the decay of the vibration induced voltage the voltage on the stack capacitance bleeds off at different rates depending on the value of the attached resistor. This is simply the discharge of a RC circuit whereby the time constant and thus discharge rates vary as the attached load varies.

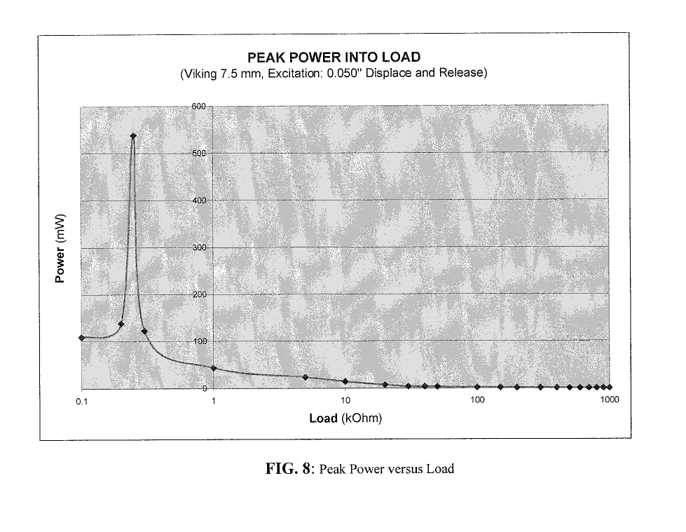

From the time history of the voltage output into the loads, and the value of the attached loads, the instantaneous power delivered into each of the loads can be determined. The maximum value of the instantaneous power into the various loads was the value calculated. The maximum power generated by the actuator will occur when a load is connected to the electrical output of the actuator that matches the electrical impedance of the stack. To determine this “optimal” load the peak power output into the various loads was plotted versus the value of the resistive load. This is shown in FIG. 8.

From FIG. 8 it can be seen that the optimal load which results in the maximum power output of the actuator is near 250 Ohms. While there is no guarantee that a load being powered by the actuator in a “real” application would equal 250 Ohms, this does provide the maximum power output that can be achieved for a given excitation and hence is a useful benchmark for the tested actuator. Also, all competitive energy harvesting companies report their power delivered into an optimal load as well, so this allows the power output of the Viking actuator to be compared to competitive energy harvesting devices. As a metric for comparison purposes the current highest performing commercial vibration energy harvesting device in the Perpetuum PMG17 which outputs 45 mW with a 1.0 gRMS vibration input. While the PMG17 is an electromagnetic 120 Hz resonant device whose operational principle is quite different from the Viking device, this nevertheless provides a value for comparison from the state-of-the-art vibration-based energy harvesting device.

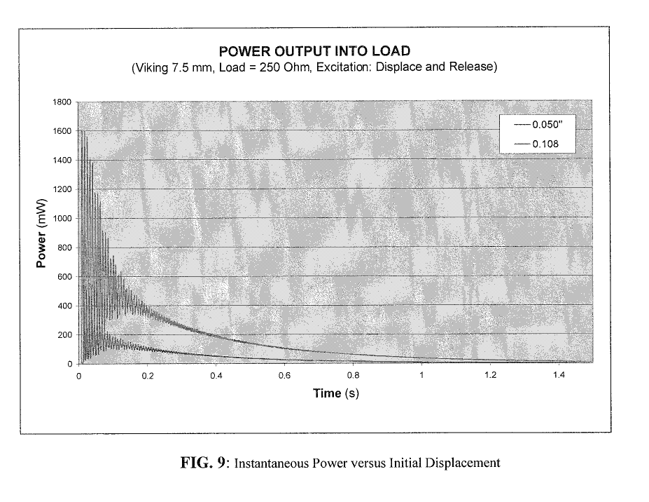

Given the optimal load for the 7.5 mm actuator was determined to be 250 Ohms, the effect of initial displacement on power output can be determined. FIG. 9 shows the instantaneous power output of the 7.5 mm actuator into the 250 Ohm optimal load for two different values of initial displacement. From the figure it can be seen that the output power increases with increasing initial displacement which is certainly expected. Also the underlying DC voltage, which represents the charge stored in the stack capacitance, increases with increasing initial displacement as well.

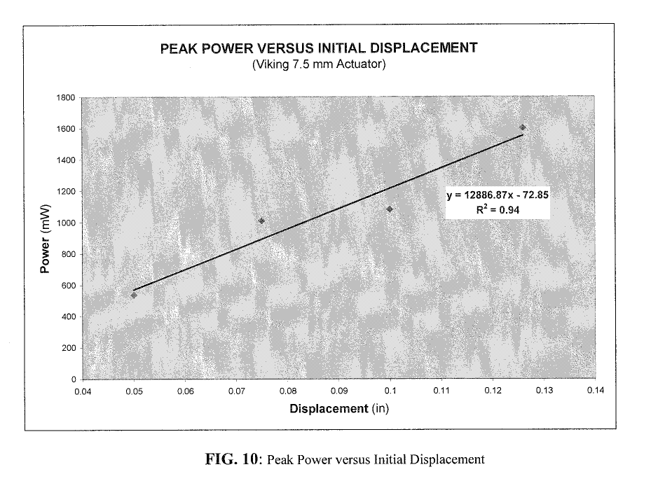

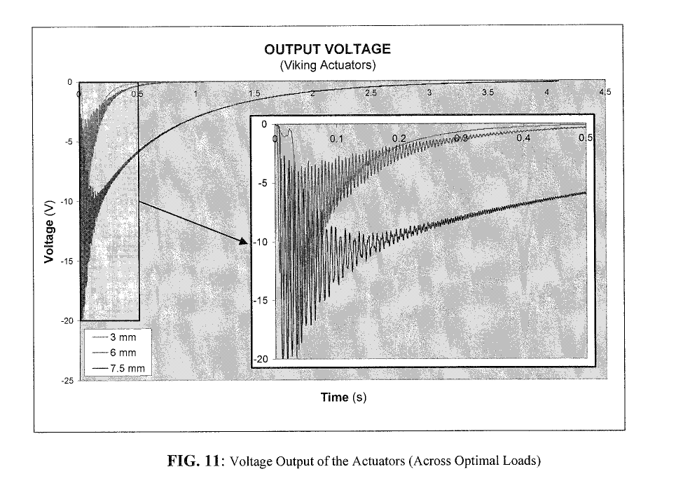

FIG. 10 is a plot of the peak power output of the 7.5 mm actuator as a function of the initial displacement. From the figure it can be seen that the peak power output is a somewhat linear function of the initial displacement.

The 3 mm and 6 mm actuators were tested using the same approach as is described above. First the optimal load was found and then the voltage output into the optimal load was recorded using the USB Oscilloscope. From the voltage data the current into the load, the power delivered, and the energy generated per excitation event can be calculated. Since the energy generated is simply the time integral of power, the energy may be derived by numerically integrating the calculated power time history. The optimal load for the 3 mm and 6 mm actuators were determined to be 270 and 230 Ohms, respectively.

FIG. 11 shows the voltage output of the 3 mm, 6 mm and 7.5 mm actuators measured across their corresponding optimal loads of 270, 230, and 250 Ohms. From the figure it can be seen that peak voltages of up to 20 V were observed into the loads. These voltages are lower than typically seen with more traditional piezoelectric energy harvesters such as a bimorph cantilever beam whose voltage outputs can be as high as several hundred Volts, depending on the excitation. However, a lower voltage output is more desirable in nearly all applications as it is usually necessary to step the voltage down to a reasonable level before it can be used in a typical application. Most candidate applications for energy harvesting are currently being powered by batteries so a standard low voltage DC output is usually desired.

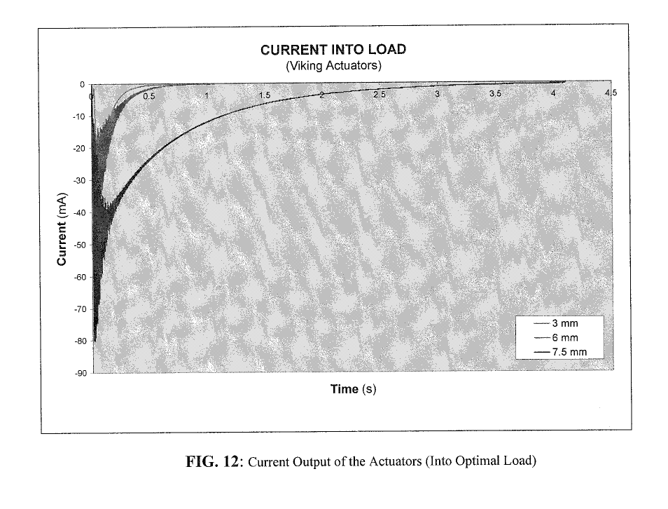

FIG. 12 shows the current delivered by the actuators into the various loads.

From the figure it can be seen that peak current outputs of as high as 80 mA were observed. Compared to other non-stack-based piezoelectric energy harvesters, this current amplitude is extremely high. Current outputs of non-stack piezoelectric energy harvesters are typically in the μA range. This is where the advantage of a stack-based energy harvester becomes readily apparent. Since the piezostack has many layers of piezoceramic material the current outputs of each layer can be summed to achieve sizable currents.

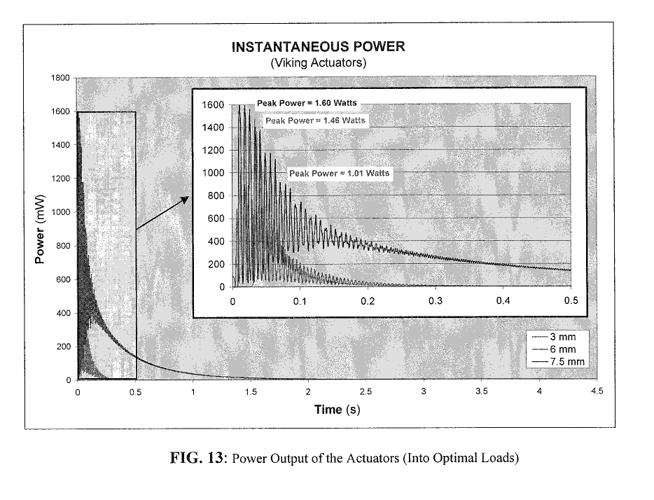

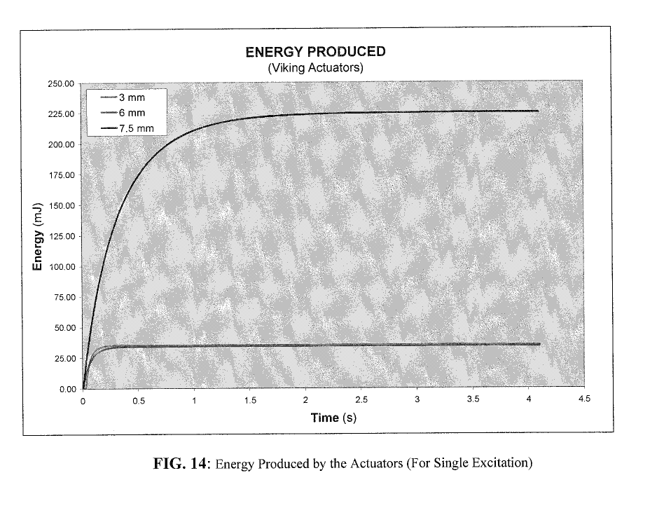

FIG. 13 shows the power delivered by the actuators into their corresponding optimal loads. From the figure it can be seen that the peak power outputs of all of the actuators are greater than one Watt with the chosen initial displacements. It should also be noted that the peak power output of the 7.5 mm actuator was 1.6 Watts. This is a tremendous amount of power for a piezo-based energy harvesting device. However, it should be noted that this is the peak power into an optimal load. The power into a load that is other than optimal will be diminished.

FIG. 14 shows the energy generated by the actuators per excitation event. From the figure it can be seen that the 7.5 mm actuator produces a far greater amount of energy than the 3 or 6 mm actuators (The fact that the energy produced by the 3 mm and 6 mm actuators is similar is just coincidental given the initial excitation and is not an inherent limitation of the actuators). However, the energy produced by all of the actuators is substantial. For comparison, the AdaptivEnergy energy harvesting module will accumulate 45 mJ in one minute with an excitation of 1.0 G amplitude at 60 Hz. To produce 225 mJ of energy with a single excitation is indicative of far greater efficiency than is available with devices known in the art.

The following table summarizes the performance of the three actuators.

| | Actuator Size | | | | | |
|---|---|---|---|---|---|---|
| Metric | 3 mm | | 6 mm | | 7.5 mm | |
| Displacement | 0.041 | in | 0.055 | in | 0.126 | in |
| Optimal Load | 270 | Ω | 230 | Ω | 250 | Ω |
| Resonant Frequency | 294 | Hz | 204 | Hz | 135 | Hz |
| Peak Voltage | 19.85 | V | 15.25 | V | 20.00 | V |
| Peak Current | 73.52 | mA | 66.30 | mA | 80.00 | mA |
| Peak Power | 1459 | mW | 1011 | mW | 1600 | mW |
| Energy per Excitation | 35.03 | mJ | 34.11 | mJ | 225.15 | mJ |

The discharge behavior of the Viking actuators may be understood by displacing the 7.5 mm actuator and observing the voltage output of the actuator across a 250 Ohm load. As the voltage in the stack decays to near 0.25 V, the 250 Ohm load is removed to illustrate the recovery characteristics of the stack in the absence of an electrical load.

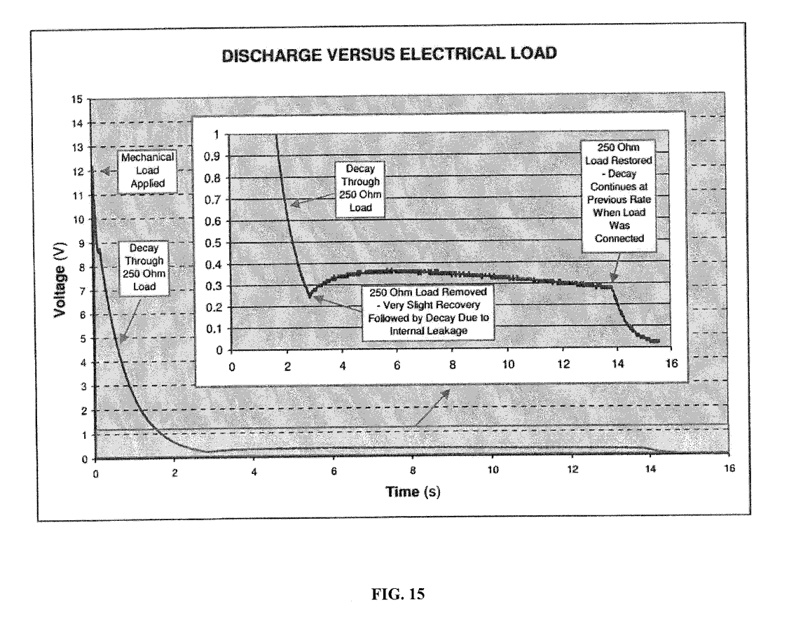

FIG. 15 is a resulting plot. From the figure it can be seen that the voltage in the stack increases to 12+ Volts following the initial displacement (In this test the actuator was displaced and then held fixed at the initial displacement value). Therefore, the initial displacement essentially charges the stack capacitance to 12+ Volts. Since there is a 250 Ohm load attached to the output of the actuator the stack voltage then begins to decay as the charge on the stack is dissipated through the resistive load. When the stack voltage reached 0.25 Volts the 250 Ohm load was removed. As the figure shows, the stack voltage then recovers slightly and then continues to decrease due to internal leakage. At the approximate 14 second mark in the figure, the 250 Ohm load is reconnected and the stack voltage begins to decay at the previous rate. This shows that the stack can only slightly recover charge even though the mechanical load continues to provide uniform strain on the stack.

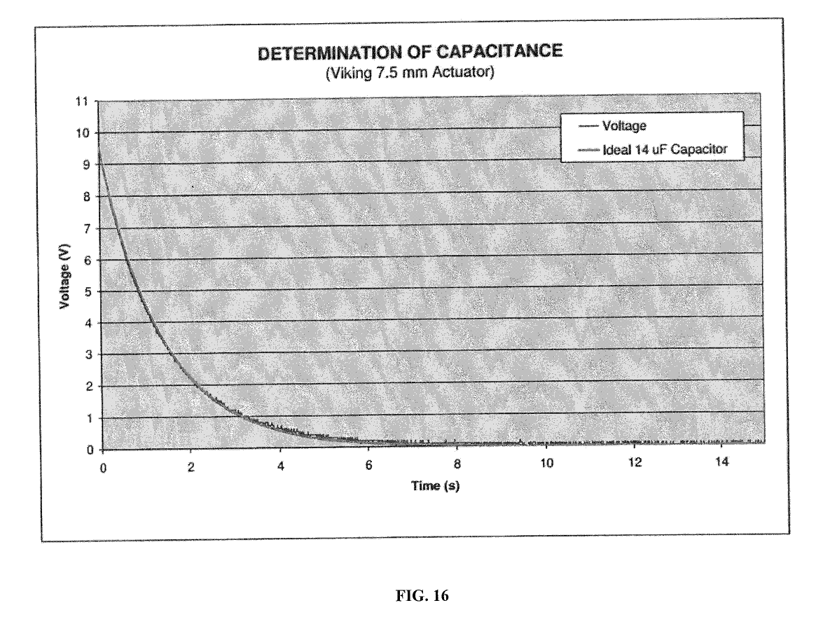

The stack may also be viewed as a capacitor with a unique ability to charge itself. Accordingly, by connecting the stack to a known resistive load, displacing it to charge it, and then monitoring the stack voltage across the load, the capacitance may be determined. FIG. 16 shows the results: a near 14 μF capacitance.

The internal leakage of the stack may be better understood by displacing the actuator arm by 0.125″ and holding it there. This initial displacement charges the stack to 17+ Volts with no electrical load. The subsequent voltage decay is due to the internal leakage of the stack and any losses in the attached data acquisition electronics.

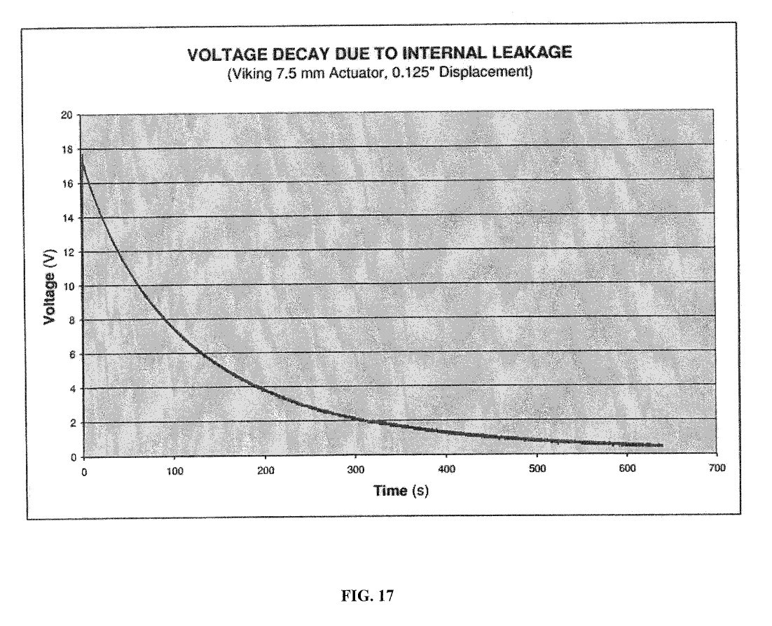

FIG. 17 shows the decay in the stack voltage due to internal leakage. From the figure it can be seen that the stack held its charge for quite a long time, taking up to fifteen minutes for a stack to completely discharge.

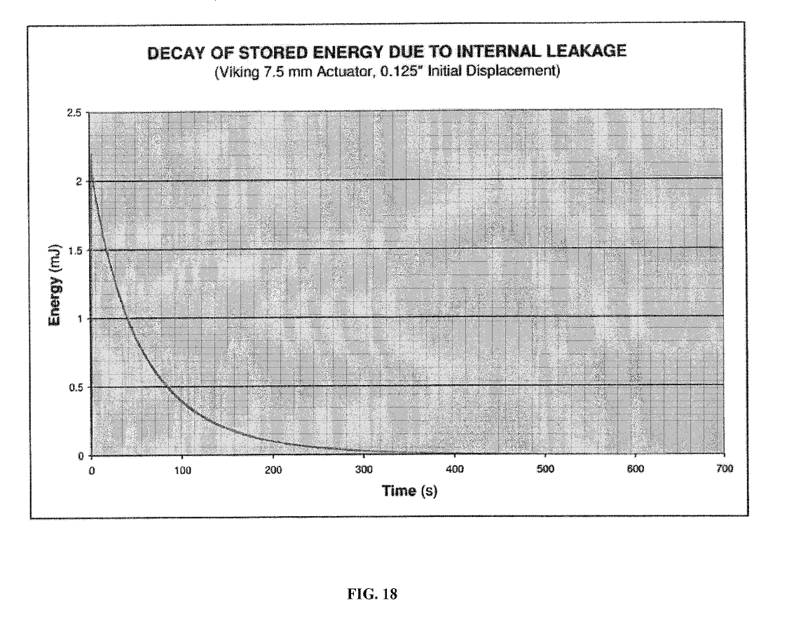

The energy stored in a stack may be calculated from the stack voltage and capacitance. FIG. 18 is a plot of the energy stored as a function of time. As voltage decays the amount of stored energy decays as well. From the figure it can be seen that better than 2 mJ of energy are stored from a single displacement of the actuator. Note that this is quite a bit less than is achieved when the actuator is “plucked” and allowed to oscillate.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

We claim:

1. A method of generating electricity from motion with a smart material actuator, the actuator comprising
a mechanical amplifier comprising a fixed supporting member having a first mounting surface, an opposed movable supporting member having a second mounting surface, at least one actuating arm, a mechanical link connecting the movable supporting member and the actuating arm; and a piezoelectric stack affixed between the first mounting surface and the second mounting surface, wherein
the fixed supporting member is substantially rigid and the first mounting surface and the second mounting surface are substantially parallel such that upon application of an electrical potential to the piezoelectric stack, the piezoelectric stack expands substantially without movement of the fixed supporting member and substantially without angular movement of the piezoelectric stack;
the mechanical link comprises at least one compliant member linking the movable supporting member and the actuating arm whereby movement of the movable supporting member causes amplified movement of the actuating arm; and
the fixed supporting member, the movable supporting member and the mechanical link are adapted such that the piezoelectric stack is compressed by a predetermined amount such that the piezoelectric stack remains compressed when no electric potential is applied and the compressive force is substantially evenly applied to the piezoelectric stack such that upon application of an electric potential, the piezoelectric material expands without significant angular flexing,
the method comprising the steps of
determining an electrical impedance of the piezeoelectric stack;
connecting an electrical load to the piezoelectric stack of the actuator wherein the electrical load substantially matches the electrical impedance of the piezoelectric stack; and
acting upon the actuator arm by a source of mechanical motion
whereby the source of motion causes the actuator arm to move, whereby the mechanical link causes the movable supporting member to exert and release pressure on the piezoelectric stack, thereby causing the piezoelectric stack to generate an electric current into the electric load.

2. A method for generating electricity from motion, the method comprising:
connecting an electrical load to an actuator comprising at least one actuator arm connected to a piezoelectric stack; and
storing in the electrical load electricity produced by the piezoelectric stack in response to movement of the actuator arm.

3. The method of claim 2 wherein the electrical load is an energy storage device.

4. The method of claim 3 wherein the energy storage device is a rechargeable battery.

5. The method of claim 2 where the actuator further comprises:
a fixed supporting member having a first mounting surface; and
an opposed movable supporting member having a second mounting surface;
wherein the piezoelectric stack is affixed between the first mounting surface and the second mounting surface.

6. The method of claim 5 wherein the fixed supporting member is substantially rigid.

7. The method of claim 5 wherein the fixed supporting member and opposed movable supporting member are substantially parallel.

8. The method of claim 2 wherein the actuator further comprises:
a mechanical link connecting the actuator arm to the piezoelectric stack.

9. The method of claim 8 wherein the mechanical link comprises at least one compliant member, whereby movement of the actuator arm causes amplified movement of the piezoelectric stack.

10. The method of claim 2 further comprising the step of
determining an optimal electrical load to connect to the piezoelectric stack.

11. The method of claim 2 wherein the piezoelectric stack is a co-fired ceramic piezo stack.

12. The method of claim 2 wherein the piezoelectric stack comprises a stack of at least one section of a single-crystal piezo material, such crystal having a positive electrode and a negative electrode.

13. The method of claim 12 wherein the positive electrodes and negative electrodes are printed on the sections of single-crystal piezo material.

14. The method of claim 13 wherein an adhesive causes the electrodes to adhere together.

15. The method of claim 13 wherein a predetermined compressive force causes the electrodes to adhere together.

16. An apparatus for harvesting energy comprising:
an actuating arm;
a piezoelectric stack;
an amplifier comprising a fixed supporting member having a first mounting surface and an opposed movable supporting member having a second mounting surface wherein the piezoelectric stack is affixed between the first mounting surface and the second mounting surface; and
a mechanical link interconnecting the actuating arm to the amplifier whereby movement of the actuating arm is focused into the piezoelectric stack causing the stack to compress or expand resulting in electrical current.

17. The apparatus of claim 16 further comprising:
an electrical load, wherein the electrical current is generated into the electrical load.

18. The apparatus of claim 17 wherein the electrical load is a battery.

19. The apparatus of claim 16 wherein the fixed supporting member is substantially rigid.

20. The apparatus of claim 16 wherein the fixed supporting member and opposed movable supporting member are substantially parallel.
